(19) United States
(12) Patent Application Publication
(10) Pub. No.: US 2015/0002486 A1
(43) Pub. Date: Jan. 1, 2015

(54) MULTIFUNCTIONAL PENCIL INPUT PERIPHERAL COMPUTER CONTROLLER

(71) Applicants: Stefan Valícek, Visnove (SK); Alexandr Mihál, Predklasteri (SK); Marek Mihál, Predklasteri (CZ)

(72) Inventors: Stefan Valícek, Visnove (SK); Alexandr Mihál, Predklasteri (SK); Marek Mihál, Predklasteri (CZ)

(73) Assignee: dolphin, s.r.o., Trencin (SK)

(21) Appl. No.: 14/241,248

(22) PCT Filed: Aug. 23, 2012
(86) PCT No.: PCT/SK2012/050013

§ 371 Date: Apr. 9, 2014

(30) Foreign Application Priority Data
Aug. 29, 2011 (SK) PUV 50087-2011

(51) Int. Cl. G06F 3/038; G06F 3/0354

(52) U.S. Cl. CPC G06F 3/0383; G06F 3/03545
USPC 345/179

(57) ABSTRACT

The multifunctional pencil input peripheral computer controller can be applied to all commercially produced computers and laptops. To the narrow longitudinal operating processor with controllers the source of electricity is connected and the functionally bidirectionally separately connected output module, the accelerometric sensor, the optical sensor, the magnetometric sensor and the gyroscopic sensor, while to the output module is remotely functionally bidirectionally connected the USB module that consists of the functionally bidirectionally linked input module and the operating processor. The controllers are formed by the tip (primary) button, the scroll button, the secondary button, the function button and the functional switch, that are mounted in any mutual order. The controllers can be formed even with another at least one extra button and/or switch.

### FIELD OF THE INVENTION

The invention relates to a new block diagram of multifunctional peripheral input pencil device for fast and convenient computer control.

### BACKGROUND OF THE INVENTION

At present, the most commonly used peripheral device for fast and easy computer control, is so called positional indicator “X-Y”, which is generally informally called “Mouse”. By using a mouse computer programs are controlled faster than by a keyboard. The user holds the mouse in his/her hand and moves it on a pad and its movement is transferred by special sensors to the cursor movement on the screen. The development of the mouse shape and number of its buttons was very rapid—the mouse with three buttons was introduced even 5 years after the first general introduction of this technical invention. The mouse has usually a position sensor located at the bottom of the body and two buttons at the top, a primary button (usually the left one) and a secondary button (usually the right one). The primary button is used most often. The majority of mice are equipped with a scroll wheel set between the buttons allowing easier scrolling of document contents and web pages. In some mice the scroll wheel can be pressed axially, thus it is functioning as a third button. More complex mice may have even more buttons which make them able to perform other functions. The position sensor, the scroll wheel, the primary, secondary and other mouse buttons are interlinked with a computer according to the well-known power scheme so that at beginnings the mouse used to be connected to the computer by a variety of special connectors, but over the time connectors PS/2 or USB, or COM left as stable. Nowadays, wireless mice based on radio, infrared, or the latest Bluetooth technologies of wireless transmission are used more and more often.

In case of a wireless mouse the source of electric current is placed in it, for example at least one pencil battery. The body of such device is of longitudinal shape, ergonomically designed to be hand-held by the user from the top so the user can easily move it by hand along with the computer keyboard on a clean and even surface, for example on a mouse pad. The mouse movement is transmitted to the cursor movement on the computer screen using special sensors. Classic mechanical-optical mice allowing the input of two-dimensional information using the position sensor in the form of a ball placed in the bottom of the mouse in the rotating manner with resolution of about 200-2400 dpi are known. Optical mice where the position sensor (ball) is replaced by a light transmitter and receiver, for example infrared (based on LED-diodes), etc., are also known. Next known mice are ultrasound or wireless mice that operate on a similar principle as the optical one, but the optical position sensor is replaced by ultrasound or radio sensors allowing also the three-dimensional input of data into the computer, because the third coordinate is here defined by the distance of the mouse position sensor (by its lifting from the pad), and have resolution of about 6000 dpi. The advantage of the mouse and mouse-oriented programs is that most frequently-used functions are offered on the monitor in form of a graphical symbol. If you want to activate the marked function, you must press the button—usually the left one (the term “click” is used). Drawing in graphic programs is more difficult using the mouse. Activity of the mouse must be supported by corresponding software that is provided directly by the manufacturer with the device.

It is impossible to use the graphic programs for drawing, especially those for children, applying the above mentioned technical devices in a technically simple manner in full scope. They do not bring such joy to the users as could be brought by maintaining the possibility of using all their current functions.

The peripheral device connected to a graphic display, called “Optical pen”, in general, is well known, too. This device allows interactive interference into the computer display. The pen is of pencil-like shape and is connected to the computer by a cable. Moreover, it is usually equipped with a so called acknowledge button. Inside the pen, a photosensitive element (e. g. phototransistor) is placed. After putting the pen to a particular point on the display and acknowledging by the acknowledgement button the pen's position is scanned. This fact is technically quite simple, because the activating impulse occurs at the moment of electronic beam's transit through the area where the pen is. At the moment, when an activating impulse is identified, the computer re-calculates the point position at the moment of activation based on synchronization and the point coordinates on the computer screen are clearly identified and quantified.

The disadvantage of this device is that it does not allow to use graphic programs for drawing outside the computer graphic display monitor and it does not allow to perform other functions and options as the common position indicator “X-Y”, i. e. “Mouse”.

According to SK ÚV 5302, the pencil input peripheral computer controllers are known, which have a position sensor incorporated in its longitudinal pencil shaped body, above which a scroll wheel of a micro switch is mounted and next to it a secondary button of a micro switch. At the end of the longitudinal pencil shaped body a position sensor is mounted, and next to scroll wheel of a micro switch and secondary button a primary button of the micro switch is incorporated in the longitudinal pencil shaped body. Alternatively, a head with position sensor is incorporated in the longitudinal pencil shaped body—firm or swivelling. It can also be fitted slidably in the longitudinal pencil shaped body or in the head, while its upper position is the primary button of a micro switch. At the end of the longitudinal pencil shaped body a position sensor may be mounted. Above or below the scroll wheel of a micro switch, a primary button of a micro switch can be mounted. Above the scroll wheel of micro switch, also the centre button of micro switch can be mounted in the longitudinal pencil shaped body. The scroll wheel of micro switch can also be slidingly axially connected with the middle button of micro switch, while above the scroll wheel, or middle button of micro switch, a protrusion created in the longitudinal pencil shaped body can form at least one additional button of micro switch. The solution is technically complex and requires longer getting used to by the user.

According to SK ÚV 5946 pencil input peripheral controllers consisting of a longitudinal pencil-like shaped body with firmly set position sensors and buttons of vertical line cursor movement are also known, under which a primary button of a micro switch and a secondary button of a micro switch interlinked to a computer are placed. In the longitudinal pencil shaped body the position sensor is found. Underneath the sensor the tip is attached, above which, on the opposite side in the longitudinal pencil shaped body, the button of vertical line cursor shift and a secondary button of micro switch are fitted. The longitudinal pencil shaped body is equipped with a position sensor with inclination of axis α in the range of 10 to 80 angle degrees, and tip is tilted at an angle β in the range of 0 to 80 angle degrees forming a primary button of a micro switch. Above, below or next to the vertical line cursor shift a secondary button of micro switch or at least one additional button and/or switch is fitted. However, the specific functional diagram of the device is not yet known.

All the above mentioned solutions require the input peripheral controller placed only on a fixed desktop, close to the display unit of the computer, which can be linked, for example, by a slide projector or a large scale display unit, or an interactive display unit with possible using a calibrated interactive pen connected to a computer and only partly replacing the input peripheral controller—mouse. Normally we use mechanical or optical pointer, for example a laser pointer. Such a pointer is inaccurate in case of greater distances and does not enable the user to use the necessary remote permanent marking of texts, their moving or scrolling of pages etc., therefore it is necessary for the user to combine its operation with an input peripheral device—the computer mouse, what is impractical.

The use of accelerometer to measure non-gravitational acceleration using inertial properties of material bodies, the magnetometer to measure the size and direction of magnetic induction or magnetic moment (i.e., magnetization) and gyrometres (tachometers) to process the direction, speed, and course of body position is well-known. The collateral use of these devices for remote control of computers in their input peripheral controller—the mouse of the computer—is not yet known.

### SUMMARY OF THE INVENTION

The above mentioned disadvantages are substantially eliminated by the multifunctional input pencil peripheral computer controller consisting of an operating processor, controllers, a power source, an output module, an accelerometric sensor, an optical sensor, a magnetometric sensor, a gyroskopic sensor and a USB module. The invention is based on the fact that the narrow longitudinal operating processor with controllers has a power source connected, as well as a separate bidirectionally connectedoutput module, an accelerometric sensor, an optical sensor, a magnetometric sensor and a gyroskopic sensor. The output module is also remotely connected with abidirectionally functional USB module composed of a functionally bidirectionally interconnected input module and a power processor.

It is quite advantageous if the controllers are composed of a tip (primary) button, a scroll button, a secondary button, a function button and a functional switch that are mounted in any mutual order, while the controllers can be formed also by another at least one extra button and/or switch.

The multifunctional pencil input peripheral computer controller according to the invention allows at standard placement of the input peripheral controller on a fixed desktop near the computer display unit also its simple, full computer remote control directly from the user's hand. This is particularly useful when connecting the computer with a slide projector or with a large scale display unit or interactive display unit for eventual use of the calibrated interactive pen independently linked to a computer. This fact replaces remote use of mechanical or optical, e.g. laser, pointers to the user. The pointer is at the same time exact and allows the user the necessary remote permanent marking of a text part, its movement or scrolling pages, etc., the same as with a standard mouse and also a combination of pointer together with the input peripheral device—computer mouse. The device according to the invention simplifies, cheapens and enables faster, easier use of computer technology by the user. The technical solution shown by the block diagram is of small size, in a shape of a pencil and allows the user to use graphical programs easily to draw on the computer, outside its graphical display monitor and also performs all other functions and options like a usual position indicator “X-Y”, i. e. “Mouse”, or “X-Y-Z’, thus extending the range of peripheral devices for computer control.

### BRIEF DESCRIPTION OF THE DRAWINGS

FIG. 1 shows schematically a particular example of execution of the block diagram of the multifunctional pencil input peripheral computer control invention.

### DETAILED DESCRIPTION

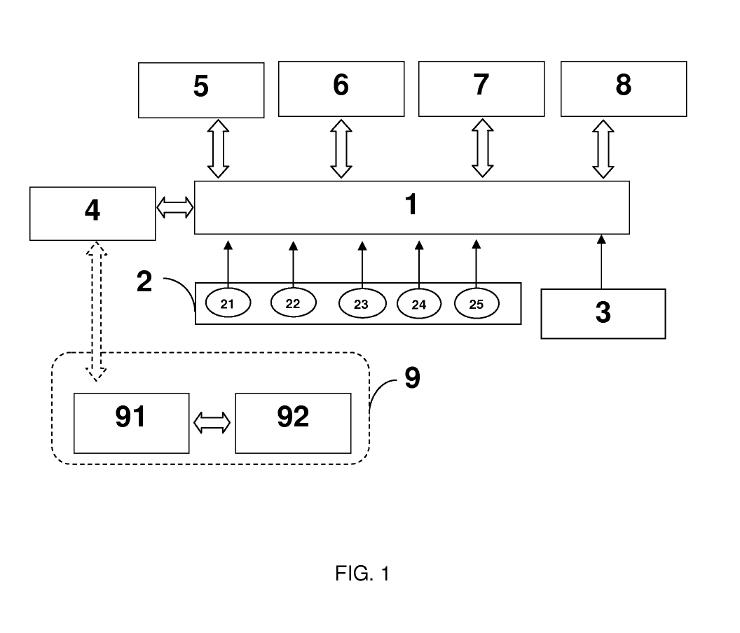

The specific example of execution of the block diagram of the multifunctional pencil input peripheral computer controller according to the invention shown in FIG. 1 consists of the operating processor 1, the controllers 2, the source 3 of electric energy, the output module 4, the accelerometric sensor 5, the optical sensor 6, the magnetometric sensor 7, the gyroskopic sensor 8 and the USB module 9, which is composed of functionally bidirectionally linked input module 91 and power processor 92. Controllers 2 are at the same time formed by cylindrical (primary) button 21, scrolling button 22, secondary button 23, function button 24 and functional switch 25.

The operating processor 1 is electrically attached with the controllers 2, the source 3 of electric energy, e. g. a pencil battery, the output module 4, the accelerometric sensor 5, the optical sensor 6, the magnetometric sensor 7 and the gyroskopic sensor 8. The controllers 2 are formed by the cylindrical (primary) button 21, the scrolling button 22, the secondary button 23, the function button 24 and the functional switch 25. With the exception of the USB module 9 all the functioning parts of this device are placed in the not displayed longitudinal pencil-like shaped body with the incorporated optic position sensor 6, under which an adjustable tip is mounted, forming tip (primary) button 21 of a micro switch, above which at the opposite side inside the body a scrolling button 22 of vertical line cursor shift is placed, and above it the secondary button 23 of a micro switch, the function button 24 of a micro switch for remote transmitting of the cursor movement and the functional switch 25 of the device “Mouse/Pointer”. The specific external design of the above described realisation results e.g. from SK UV 5946. The USB module 9 is also linked with the output module 4 according to not shown commonly known electric wiring diagram for controlling mice for computers, so that it is possible to connect it with the computer by known methods, i. e. with help of various special connectors or by PS/2, or USB connectors, or COM, or by not shown radio, infrared or Bluetooth technologies of wireless transfer and so on.

The device, according to the invention, is actuated in the position indicator mode “X-Y” or “X-Y-Z”, i. e. “Mouse” by switching the functional switch 25 to the adequate position, by which it is connected to the source 3 of electric energy with disengaging the function “Pointer”. In this position the operation processor 1 periodically reads values from its individual buttons 2 (i. e. the tip (primary) button 21, the scroll button 22, the secondary button 23, the function button 24 micro switch and the functional switch 25 of the device), the optical sensor 6 (i. e. scanning of documents on the basis of image correlation in axis “X, Y”), the accelerometric sensor 5 (i.e. scanning orientation of the device against the gravitational field of earth in axis “X, Y, Z”), the magnetometric sensor 7 (i. e. scanning orientation of the device against magnetic field of earth) and the gyroskopic sensor 8 (i.e. scanning rotary motion of the device). The operating processor 1 then wirelessly sends the mentioned values via the output module 4 to the USB module 9. These values are then in the not described known manner received by the USB module 9 to the operating processor 92 via the input module 91 of the computer, where in the known manner these values are on the basis of calibration values recalculated into sequent values of cursor movement in axis “X, Y”. At the same time it uses the values of the magnetometric sensor 7 and the gyroskopic sensor 8 for correction of calibration values so the axis “X” and “Y” had the same direction even with different angle of the multifunctional pencil input peripheral computer controller at the user. When pushing and holding the scroll button 22 the operating processor 92 recalculates values from the operating processor 1 and the optical sensor 6 (from the movement of the device on the pad) and sends the result in the above mentioned manner to the computer as the axes “Z” (which results as scrolling of the picture in the same manner as with the standard mouse). When pressing the function button 24 activation of special scrolling regime appears (rolling is initial, and pitching is available), where the scrolling (change of value of axes “Z”) is calculated from values supplied by the accelerometric sensor 7, so not with a help of values from the optical sensor 6. The rolling mode is again deactivated by pressing the function key 24.

According to the invention the user actuates the device in the position indicator modes “X-Y” or “X-Y-Z”, i.e. “Mouse” by switching the functional switch 25 from zero (starting) position to the position for “Mouse” and grips the multifunction pencil input peripheral computer controller according to the invention by hand under suitable inclination at the surface of the not shown elongated pencil like body like when writing with a thicker standard pencil so that the tip of the tip (primary) button 21 freely moves in various directions over smooth and clean surfaces, e.g. a table, paper or the most suitably over a commonly used mouse pad and so on. The movement of the tip of the tip (primary) button 21 is immediately automatically transferred as cursor movement on the screen of the computer. Any possible three-dimensional input of data into a computer, i.e. the third coordinate, the device allows to set by the appropriate distance of the position sensor (its lifting to the required height) from the pad. At the same time the user, by fingers, in known manner like with a normal mouse, controls the computer by pressing the appropriate buttons, i.e. the tip of the tip (primary) button 21, pressing or pressing with holding of the scroll button 22 and pressing of the secondary button 23. When finished, the user according to the invention deactivates the device by switching the functional switch 25 back from the position for “Mouse” to the zero (initial) position.

The device, according to the invention, is actuated in the position indicator mode “Pointer” by switching the functional switch 25 to any adequate position by which it is connected with the source 3 of electric energy with disengaging the function of the position indicator “X-Y” or “X-Y-Z”, i.e. “Mouse”. In this position, the tip (primary) button 21 and the optical sensor 6 are automatically disabled. The operating processor 1 periodically downloads values from its individual buttons 2 (i. e. the scroll button 22, the secondary button 23, the function button 24) and the functional switch 25, the accelerometric sensor 5 (i.e. scanning orientation of the device against the gravitational field of earth in axis “X, Y, Z”), the magnetometric sensor 7 (i. e. scanning orientation of the device against the magnetic field of earth) and the gyroskopic sensor 8 (i.e. scanning rotary motion of the device) and calculates orientation of the device in space and its changes, while calculation determines movement of the cursor in axes “X” and “Y” on the display unit of the computer. The mentioned values the operating processor 1 then in the same manner as in the position indicator regime “X-Y” or “X-Y-Z”, i.e. “Mouse” wirelessly sends via the output module 4 to USB module 9. From the calculating point of view the used algorithm processes current results from the accelerometric sensor 5, the magnetometric sensor 7 and the gyroskopic sensor 8 at the same time, while current 3D spatial orientation (i.e. net rotating component of the position with 3 degrees of freedom) of the device to the earth's gravity and the magnetic field of the earth is estimated. From the observed changes in 3D orientation of the device the power processor 92 in the same way as in function of the positional indicator “X-Y” or “X-Y-Z”, i.e. “Mouse” calculates angular deviation and movement of the cursor on a computer display unit. Algorithms estimating the actual spatial 3D orientation of the device in the form of an analytical calculation or dynamic estimation in time are used. Analytical calculation and dynamic estimation are based on the fact that the results of the accelerometeric sensor 5, the magnetometric sensor 7 and the gyroskopic sensor 8 measure projection of vector of force field to three axis of the mouse coordinates system, i.e.: y=R*u, where “y” is projected vector, “u” is vector of gravity (magnetism in the world coordinate system and “R” is orthogonal matrix 3×3 representing 3D orientation of the device). The cursor on the display unit is moving only when you activate the scroll button 22 of a micro switch by spatial movement of the device—pointer by the user. After the release of the scroll button 22 the cursor stops regardless of the further movement of the device and then it is possible to control it with the secondary button 23 (replacing the tip (primary) button 21).

Both modes use multichannel two-way wireless communication, by which the operating processor 1 can send acknowledgments of receipt of data and switch sensor modes. If this acknowledgement is not issued within a set time, the operating processor temporarily disconnects the accelerometric sensor 5, the magnetometric sensor 7 and the gyroskopic sensor 8 from the source (3) of electricity, thereby saving electrical power of the source (3) of the device. Moreover, the multichannel wireless communication allows you to operate simultaneously several such devices in one room.

The user puts the device according to the invention in operation in the mode “Pointer” by switching the functional switch 25 from the zero (initial) position to the “Pointer” and grabs the multifunctional pencil input peripheral computer controller according to the invention by hand at the surface of the longitudinal not shown pencil-like shaped body, like they would use a laser pointer. Then presses the scroll button 22 and remotely aims the tip of the tip (primary) button 21 to a representation of the display unit of computer, for example on a projection screen or large screen and so on, and the movement of the tip of the tip (primary) button 21 is immediately automatically transferred through the computer to cursor movement on the display unit to the suitable position, where it, after releasing of the scroll button 22, stops. It is also possible to remotely control the cursor on the display unit by the user directly from the hand without any pad from the computer in the same way like in the mode “Mouse”. After completing the work, the user deactivates the device according to the invention by reverse switching of the functional switch 25 from the position “Pointer” to the zero (initial) position.

The described and illustrated realisations are not the only possible solutions according to the invention, because the controllers 2 made by the tip (primary) button 21, the scroll button 22, the secondary button 23, the function button 24 and a the functional switch 25, can be mounted in the device in any mutual position and also can be formed even with another at least one invisible additional button and/or switch.

### INDUSTRIAL APPLICABILITY

The multifunctional pencil input peripheral computer controller according to the invention can be applied to all commercially produced computers and laptops.

### LIST OF USED ASSOCIATED LABELS

1—Operating processor

2—Controllers

21—Tip (primary) button

22—Scroll button

23—Secondary button

24—Function button

25—Function switch

3—Source (of electric energy)

4—Output module

5—Accelerometric sensor

6—Optic sensor

7—Magnetometric sensor

8—Gyroskopic sensor

9—USB module

91—Input module

92—Power processor

1. The multifunctional pencil input peripheral computer controller consists of an operating processor, the controllers, a source of electricity, the an output module, an accelerometric sensor, an optical sensor, a magnetometric sensor, a gyroskopic sensor and an USB module (9), wherein a narrow longitudinal operating processor with controllers has the source of electricity connected and the functionally bidirectionally separately connected output module, the accelerometric sensor, the optical sensor, the magnetometric sensor and also the gyroscopic sensor, while the output module is remotely functionally bidirectionally connected with the USB module consisting of the functionally bidirectionally linked input module and the performance processor and wherein the controllers are formed by a tip button, a scroll button, a secondary button, a function button and a functional switch that are mounted in any mutual order.

2. (canceled)

3. The multifunctional pencil input peripheral computer controller according to the claim 1, being distinguished by that the controllers consist of at least one other additional button and/or switch.
